(19) United States
(12) Patent Application Publication
(10) Pub. No.: US 2008/0027807 A1
(43) Pub. Date: Jan. 31, 2008

(54) STREAMING CONTENT DISTRIBUTION SYSTEM AND STREAMING CONTENT DISTRIBUTION METHOD

(75) Inventor: Kiyoto Matsumoto, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC Corporation, Tokyo (JP)

(21) Appl. No.: 11/782,435

(22) Filed: Jul. 24, 2007

(30) Foreign Application Priority Data
Jul. 25, 2006 (JP) 2006-201718

(51) Int. Cl. G06Q 30/00

(52) U.S. Cl. 705/14

(57) ABSTRACT

Disclosed is a streaming content distribution method for distributing a content designated by a user terminal with at least one advertisement, the method comprising including: displaying alternative advertisement information about at least one alternative advertisement to be distributed instead of the advertisement during playing the advertisement at the user terminal; and changing, when the alternative advertisement information is designated by the user terminal, the advertisement being played to the alternative advertisement corresponding to the designated alternative advertisement information to perform a streaming content distribution of the alternative advertisement. A streaming content distribution system including a streaming content distribution apparatus connected to a network and a user terminal is also disclosed.

### RELATED APPLICATIONS

This application is based on Japanese Patent Application No. JP 2006-201718 filed on Jul. 25, 2006, and including a specification, claims, drawings and summary. The disclosure of the above Japanese Patent Application is incorporated herein by reference in its entirety.

### BACKGROUND OF THE INVENTION

1. Field of the Invention

The present invention relates to a streaming content distribution system and a streaming content distribution method for distributing streaming contents in which at least one advertisement is included.

2. Description of the Related Art

A streaming content distribution service using the Internet is known. Japanese Patent Application Laid-Open No. 2002-281483 discloses an example of such streaming content distribution system.

The disclosed streaming content distribution system includes an advertisement database server, a content database server, a portal server, a content processing server and a streaming content distribution server.

The advertisement database server is a database server which stores a plurality of streaming advertisements. The content database server is a database server which stores a plurality of streaming contents including information about an inserting position of a streaming advertisement. The portal server includes a function which allows a viewer to select the streaming advertisement and the streaming content. The content processing server includes a function to read out the selected streaming advertisement and the selected streaming content from respective database servers. Moreover, the content processing server includes a function to insert the streaming advertisement in the streaming content according to the information about an inserting position of the streaming advertisement. The streaming content distribution server includes a function to distribute the streaming content and the streaming advertisement to a user terminal device via a network.

The streaming content distribution system including such configuration operates as follows. First, a member registration process is carried out in the portal server. In the member registration process, the portal server transmits information for a member registration screen to the user terminal device. The user terminal device displays a member registration screen based on the received information for a member registration screen. A user operates the user terminal device and inputs user identification, a password and personal information to request a registration. Next, the user operates the user terminal device to access the portal server, and inputs the user identification and a password to conduct login. The portal server which accepts the login searches the content database server, generates a content list screen for distribution and transmits the content list screen to the user terminal device.

The user sees the content list screen displayed on the user terminal device and operates the user terminal device to select a desired content. In response to the selection, the portal server reads out advertisement related information and an advertisement thumbnail still image from the advertisement database server to generate an advertisement selection screen and transmit it to the user terminal device. When seeing the advertisement selection screen, the user sets the number of times that an advertisement is inserted, selects a viewing content advertisement and clicks a view start button at the user terminal device. Then, the streaming content distribution system inserts the selected advertisement in the selected content by the number of times of inserting set by the user. Then the system performs a streaming content distribution to the user terminal device that is a source of request.

However, a streaming content distribution system in such related art has following problems. First, when a content of a distributed advertisement is not attractive to a user, an advertisement distribution is not effective. That is because a user can not change the distributed advertisement to another advertisement during a streaming content distribution even if the user is not interested in the distributed advertisement. As a result, because the user has no other way except to wait for a completion of the advertisement, information of the advertisement does not effectively reach the user.

Japanese Patent Application Laid-Open No. 2005-6105 discloses a content distribution system in which an alternative content is inserted when a user skips the distributed advertisement. In the content distribution system, a user can view an alternative content by skipping an advertisement when the user is not interested in the distributed advertisement. However, in this case, the alternative content has to be a content which does not give a disadvantage to an advertiser. Therefore, it cannot be selected by the user's selection. Accordingly, the alternative content is not necessarily a content in which a user is interested at the time.

Next, a second problem of a content distribution system is that a streaming content distribution service can not be quickly started. A user has to register information about a distributed advertisement in advance and needs some effort to do that.

### SUMMARY OF THE INVENTION

The present invention was made to solve the foregoing and other exemplary problems, drawbacks, and disadvantages.

It is an object of the present invention to provide a streaming content distribution system and a streaming content distribution method in which a user can change distributed advertisement to other advertisement during viewing, when the advertisement in which a user is not interested is distributed. It is an object of the present invention to provide a streaming content distribution system and a streaming content distribution method in which it is unnecessary for a user to make a complicated registration procedure for an advertisement in advance.

The present invention provides a streaming content distribution method for distributing a content designated by a user terminal with at least one advertisement, the method including: displaying alternative advertisement information about at least one alternative advertisement to be distributed instead of the advertisement during playing the advertisement at the user terminal; and changing, when the alternative advertisement information is designated by the user terminal, the advertisement being played to the alternative advertisement corresponding to the designated alternative advertisement information to perform a streaming content distribution of the alternative advertisement.

Further, the present invention provides a streaming content distribution system including a streaming content distribution apparatus connected to a network and a user terminal, the streaming content distribution apparatus distributing a content designated by the user terminal with at least one advertisement, wherein: the streaming content distribution apparatus transmits alternative advertisement information about at least one alternative advertisement to be distributed instead of the advertisement to the user terminal, the user terminal displays the alternative advertisement information during playing of the advertisement and notify the streaming content distribution apparatus, when the alternative advertisement information is designated, of the designated alternative advertisement information, the streaming content distribution apparatus stops a streaming content distribution of the advertisement in response to the notification from the user terminal and starts a streaming content distribution of an alternative advertisement corresponding to the designated alternative advertisement information.

According to the present invention, an effect of an advertisement can be maximized with respect to a distribution of an advertisement. That is, because it is possible for a user to change an advertisement that is distributed to another advertisement in which the user is interested during viewing, a user can actively view an advertisement. Moreover, because a user can designate an advertisement which the user want to see without making a prior registration of information about an advertisement to be distributed, the user can quickly start using a content distribution service.

### BRIEF DESCRIPTION OF THE DRAWINGS

Exemplary features and advantages of the present invention will become apparent from the following detailed description when taken with the accompanying drawings in which:

FIG. 1 is a functional block diagram showing a whole structure of an exemplary embodiment of the present invention.

FIG. 2A is a view showing an outline of operation before a change of a content distribution table in an exemplary embodiment of the present invention.

FIG. 2B is a view showing an outline of operation after a change of a content distribution table in an exemplary embodiment of the present invention.

FIG. 3 is a flowchart illustrating a detailed operation of an exemplary embodiment of the present invention.

FIG. 4A is a figure showing a specific example of a content of a content distribution table at the time of a first distribution of content in an exemplary embodiment of the present invention.

FIG. 4B is a figure showing a specific example of a content of a content distribution table after a change of an advertisement in an exemplary embodiment of the present invention.

FIG. 5, FIG. 6, FIG. 7 and FIG. 8 are figures each showing an example of a screen display of a video player that is activated in a user terminal in an exemplary embodiment of the present invention.

FIG. 9A is a figure showing an outline of operation before a change of a content distribution table in another exemplary embodiment of the present invention.

FIG. 9B is a figure showing an outline of operation after a change of a content distribution table in another exemplary embodiment of the present invention.

FIG. 10 and FIG. 11 are figures each showing an example of a screen display of a video player that is activated in a user terminal in another exemplary embodiment of the present invention.

### DETAILED DESCRIPTION OF THE EXEMPLARY EMBODIMENTS

Exemplary embodiments of the present invention will now be described in detail in accordance with the accompanying drawings.

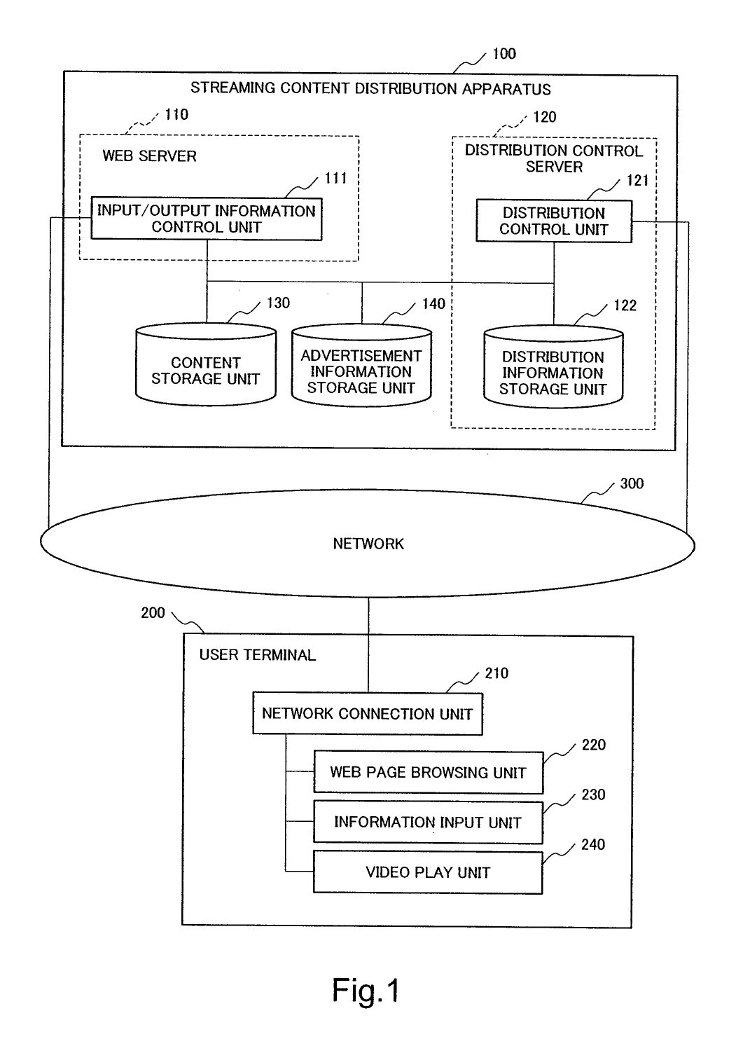

FIG. 1 is a functional block diagram showing a whole structure of an exemplary embodiment of the present invention.

Referring to FIG. 1, an exemplary embodiment of the present invention includes a streaming content distribution apparatus 100 and a user terminal 200 that are connected to a network 300. The streaming content distribution apparatus 100 includes a Web server 110, a distribution control server 120, a content storage unit 130 and an advertisement information storage unit 140.

The Web server 110 is provided with an input/output information control unit 111. The input/output information control unit 111 is connected to the network 300 and includes a function to accept a distribution request from the user terminal 200. The distribution control server 120 includes a function to distribute a content based on a request from the user terminal 200. In order to perform the function, the distribution control server 120 includes a distribution control unit 121 and a distribution information storage unit 122.

Here, the network 300 means a network including the Internet. A connection between the network 300 and the streaming content distribution apparatus 100, and a connection between the network 300 and the user terminal 200 may be formed by a wired connection or a wireless connection.

The user terminal 200 includes a network connection unit 210, a Web page browsing unit 220, an information input unit 230 and a video play unit 240. The user terminal 200 includes a configuration as a well-known information communication terminal, for example, a personal computer including a communication function or a portable communication terminal device. That is, the user terminal 200 includes at least a hardware for communication, a hardware for an input/output as a user interface (for example, a display, a touch panel, an input key, a mouse etc.), a processor that is a control device for controlling an operation of a whole device and a memory storing data or a program, etc. In FIG. 1, a hardware configuration thereof is not shown and a functional block is shown. Functions of the network connection unit 210, the Web page browsing unit 220, the information input unit 230 and the video play unit 240 are realized by a processor executing a program stored in a memory to control each hardware.

In the Web server 110, the input/output information control unit 111 accepts a request from the user terminal 200 via the network 300. Upon receiving the request, the input/output information control unit 111 transmits a menu screen of contents for a streaming distribution to the user terminal 200. When a distribution content is designated through a menu screen in the user terminal 200, the input/output information control unit 111 accepts the designation via the network 300. Moreover, the input/output information control unit 111 notifies the user terminal 200 of a setting status for a distribution.

In the distribution control server 120, upon receipt of a request from the user terminal 200, the distribution control unit 121 generates or updates a content distribution table. The distribution control unit 121 transmits the content distribution table that has been generated or updated to the user terminal 200. Moreover, the distribution control unit 121 distributes a content and a moving image (i.e., video) advertisement, and transmits an alternative advertisement information to the user terminal 200.

The distribution information storage unit 122 stores the content distribution table that is generated or updated by the distribution control unit 121, and stores update record data of each content distribution table. The content storage unit 130 stores video contents to be distributed to the user terminal 200. The advertisement information storage unit 140 stores video advertisements to be distributed to the user terminal 200 and associated information about each of video advertisements.

In the user terminal 200, the network connection unit 210 connects with the streaming content distribution apparatus 100 via the network 300. The Web page browsing unit 220 displays a Web page such as a menu screen of contents for a streaming distribution that is transmitted from the Web server 110 on a display (not shown). The information input unit 230 includes a function for inputting request information transmitted to the streaming content distribution apparatus 100. The video play unit 240 plays contents and video advertisements distributed from the distribution control server 120 on a display (not shown).

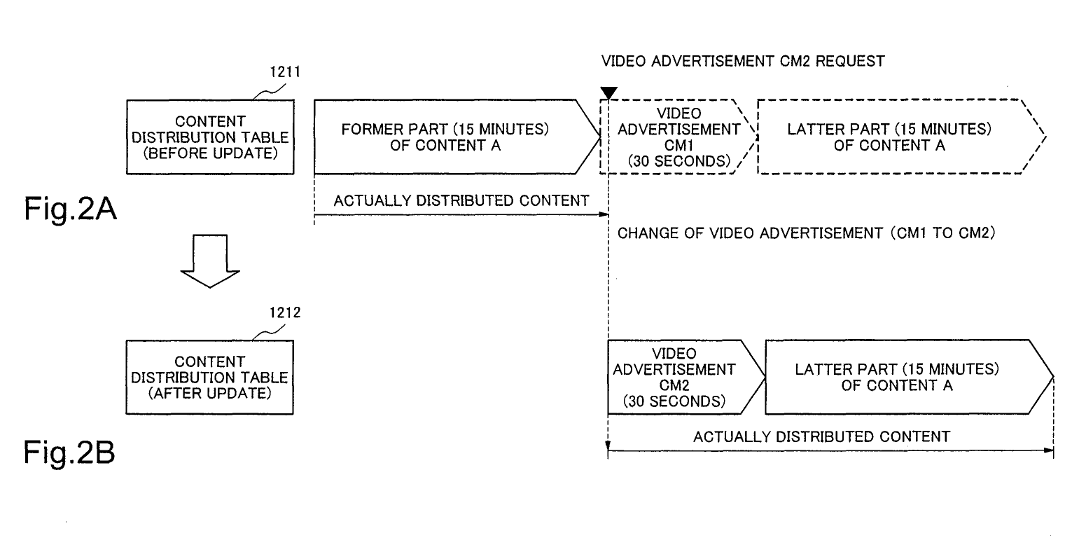

Next, an operation of an exemplary embodiment of the present invention is described with reference to the drawings. First, an outline of an operation is schematically described with reference to FIG. 2A and FIG. 2B. Here, an example of a streaming content distribution is shown as follows.
(1) User of the user terminal 200 designates a video content A having a viewing time of 30 minutes.
(2) One video advertisement having a viewing time of 30 seconds is inserted at the middle (at the time when 15 minutes has elapsed from a beginning of the content A) of the content A.

On the basis of the condition mentioned above, first, the distribution control unit 121 generates a content distribution table 1211 (before updating). According to the content distribution table 1211, the whole of the former part (15 minutes) of the content A is distributed and a viewing is completed (FIG. 2A).

Next, a distribution of a video advertisement CM1 (30 seconds) starts. However, having no interest in the video advertisement CM1, the user designates a video advertisement CM2 during a viewing of the video advertisement CM1. Then, a distribution of the video advertisement CM1 is interrupted and the content distribution table 1211 is updated to a new content distribution table 1212 (FIG. 2B). After that, all the video advertisement CM2 (30 seconds) is distributed according to the content distribution table 1212 (after updating). Finally, the whole of the latter part (15 minutes) of the content A is distributed.

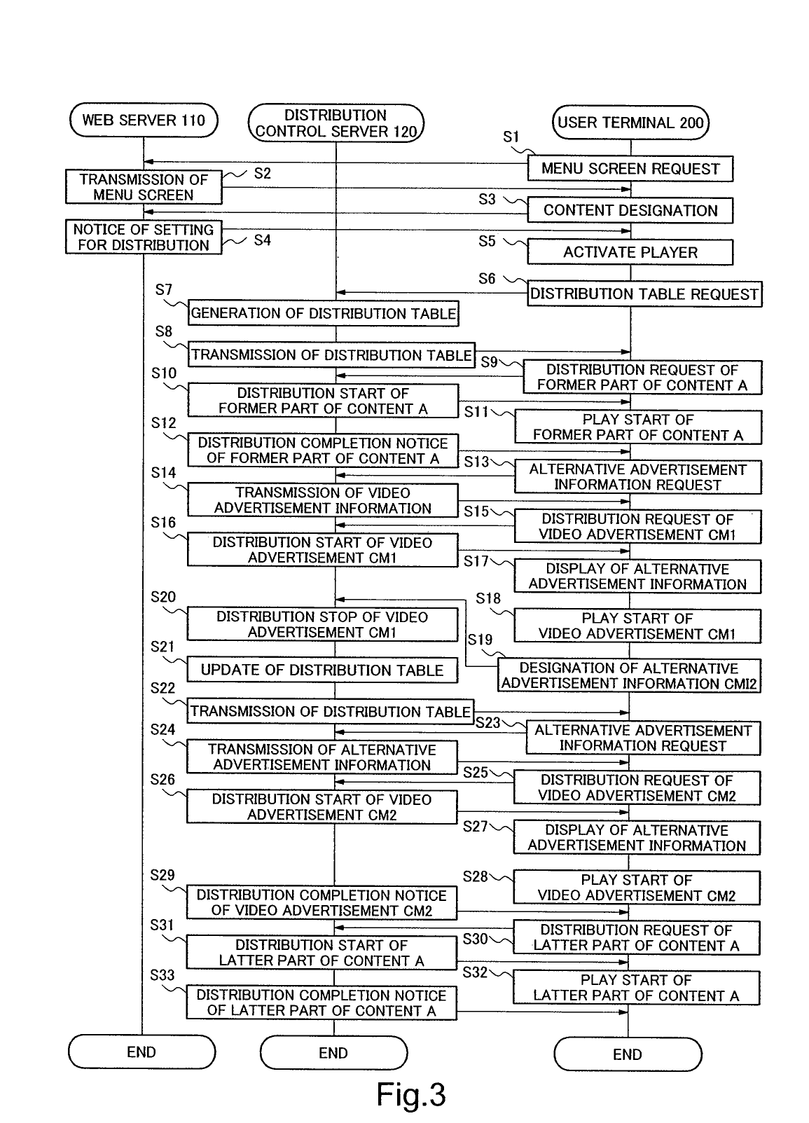

Next, an operation of an exemplary embodiment of the present invention is in detail described with reference to a flowchart shown in FIG. 3. First, the network connection unit 210 of the user terminal 200 accesses the Web server 110 via the network 300 (e.g., the Internet). The Web page browsing unit 220 (e.g., a Web browser etc.) requests a menu screen of contents for a streaming distribution to the Web server 110 (step S1 in FIG. 3). Upon receipt of the request, the Web server 110 transmits a menu screen of contents for a streaming distribution to the user terminal 200 (step S2). In the user terminal 200 which receives the information of the menu screen, the Web page browsing unit 220 displays the menu screen of contents for a streaming distribution on a display (not shown). The user of the user terminal 200 can see a list of viewable video contents through a streaming distribution on the menu screen.

Next, the user designates a video content, by using the information input unit 230, of which the user requests a streaming content distribution. The designation of content is transmitted to the input/output information control unit 111 of the Web server 110 (step S3). The input/output information control unit 111 notifies the user terminal 200 of information of a setting status for a distribution with respect to the designated content (step S4). The notice of a setting status for a distribution to the user terminal 200 includes information about activation of a video player and a connection to the distribution control server 120. Upon receipt of the notice, the user terminal 200 activates the video play unit 240 (a video player etc. that is installed in advance) (step S5).

Moreover, the user terminal 200 accesses the distribution control server 120 to request a content distribution table with respect to the designated content (step S6). Upon receipt of the request, the distribution control unit 121 of the distribution control server 120 refers to information about a content and a video advertisement which are stored in the streaming content distribution apparatus 100 and generates a content distribution table with respect to the content requested by the user terminal 200 (step S7).

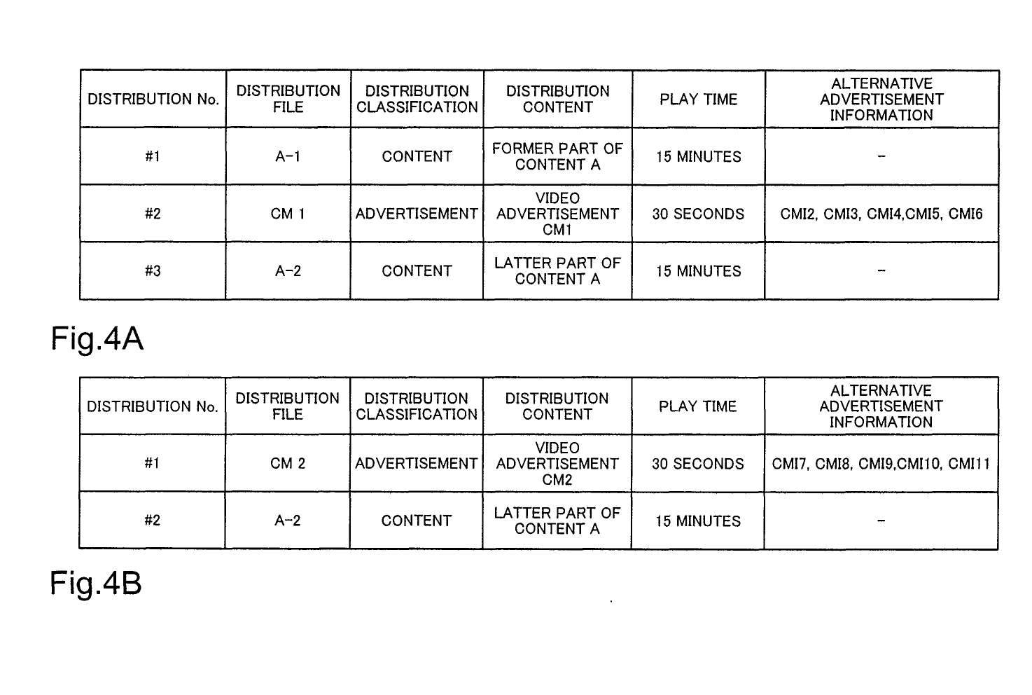

When one video advertisement is inserted in the requested content A, a content distribution table for the content A is shown as FIG. 4A. In an example of the content distribution table shown in FIG. 4A, a former part of the content A (distribution file A-1), the video advertisement CM1 (distribution file CM1) and a latter part of the content A (distribution file A-2) are distributed in this order. When the video advertisement CM1 is played, alternative advertisement information for video advertisements CM2 to CM6 are displayed on a screen. The distribution control unit 121 stores the generated content distribution table in the distribution information storage unit 122 and also transmits it to the user terminal 200 (step S8). The stored content distribution table is used for a management of a streaming content distribution to the user terminal 200.

The user terminal 200 stores the received content distribution table in a memory (not shown). Next, the user terminal 200 refers to the content distribution table to request a streaming content distribution of the former part of the content A (distribution file A-1) to the distribution control server 120 (step S9). Upon receipt of the request, the distribution control server 120 reads out the former part of the content A from the content storage unit 130, and starts a streaming content distribution thereof to the user terminal 200 (step S10). Upon receipt of the streaming content distribution, the video play unit 240 (e.g., a video player) of the user terminal 200 starts to play the former part of the content A (step S11).

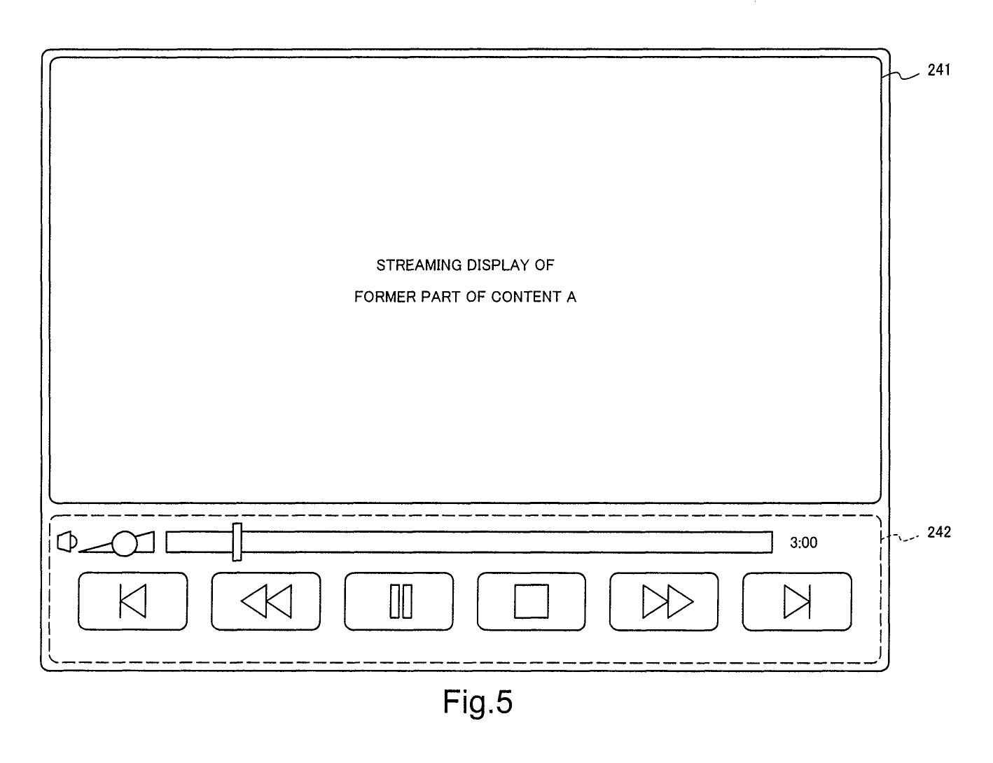

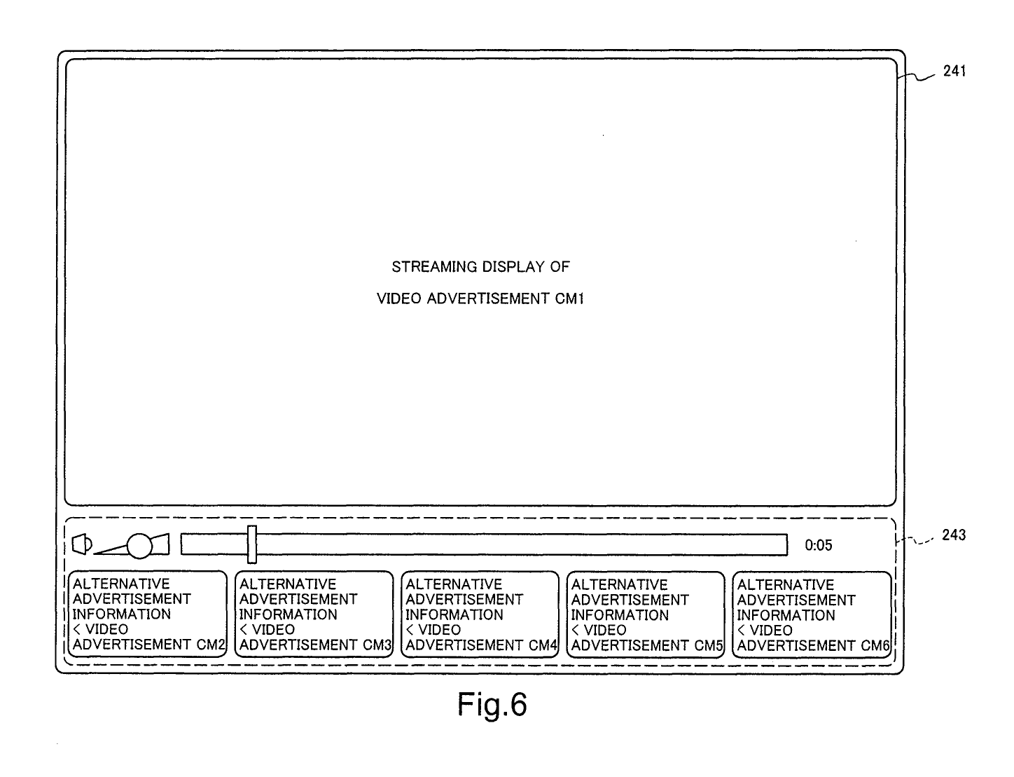

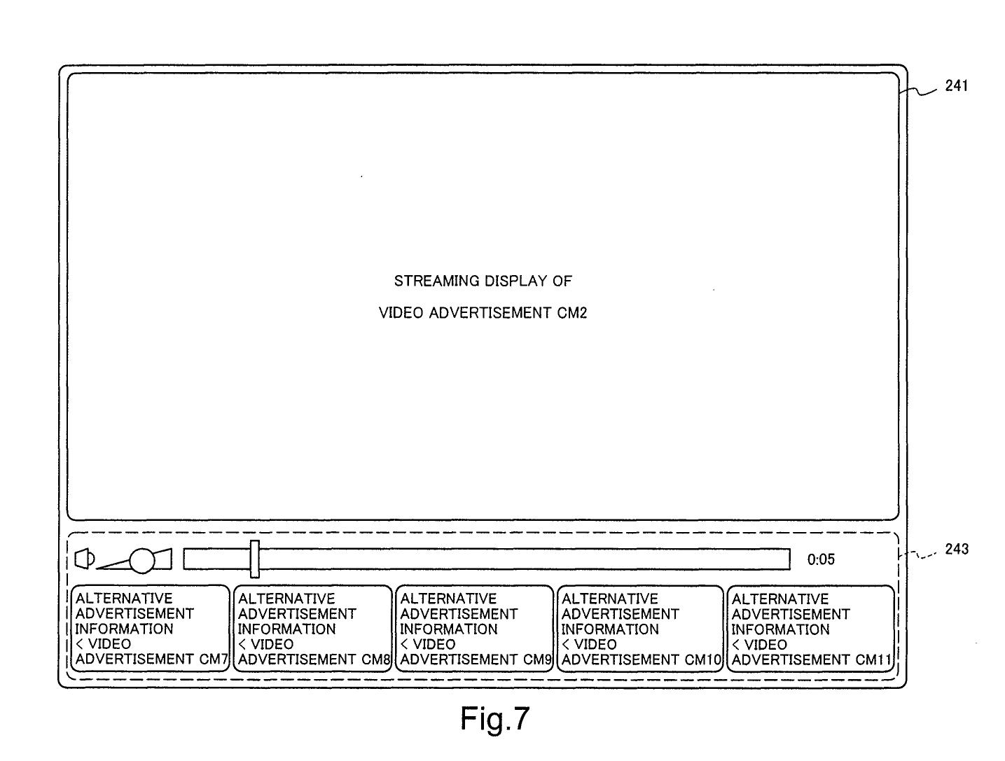

Here, FIG. 5 shows an example of a screen display of the video player of the user terminal 200. In the screen display, the former part of the content A is played in an image display area 241 and operation buttons such as volume adjustment, pause, fast forwarding are displayed in an operation panel display area 242.

When the streaming content distribution of the former part of the content A is completed, the distribution control unit 121 of the distribution control server 120 notifies the user terminal 200 of the completion of the distribution of the former part of the content A (step S12). Upon receipt of the notice, the user terminal 200 refers to the content distribution table and requests alternative advertisement information for five alternative advertisements (i.e., advertisement information CMI2 to CMI6) to the distribution control server 120 (step S13). Upon receipt of the request, the distribution control server 120 transmits the requested alternative advertisement information to the user terminal 200 (step S14).

Next, the user terminal 200 refers to a content distribution table and requests a streaming content distribution of the video advertisement CM1 to the distribution control server 120 (step S15). Upon receipt of the request, the distribution control unit 121 of the distribution control server 120 reads out the video advertisement CM1 from the advertisement information storage unit 140 and starts a streaming content distribution thereof to the user terminal 200 (step S16).

The video player of the user terminal 200 changes a screen display so as to display alternative advertisement information for five alternative advertisements (the advertisement information CMI2 to CMI6) obtained in the step S14 (step S17). At the same time, the video player of the user terminal 200 starts to play the video advertisement CM1 (step S18).

Here, FIG. 6 shows an example of a screen display of the video player of the user terminal 200. The screen display includes the image display area 241 where the video advertisement CM1 is played and an alternative advertisement information display area 243 where alternative advertisement information of the video advertisements CM2 to CM6 is displayed. The displayed alternative advertisement information includes for example, a name or a photograph of an advertisement target product, a name of an advertisement providing company (i.e., advertisement provider), a still image which shows a part of a video advertisement etc. By a click operation of a mouse or the like, the alternative advertisement information on a screen can be individually designated. In the exemplary embodiment, the video player of the user terminal 200 is set so that a user is not allowed to perform playing operations such as a fast-forwarding operation or a skip operation during playing of the video advertisement. Therefore, in FIG. 6, any other operation buttons than that of a volume adjustment and an indication of a playing time are not shown.

Here, in the alternative advertisement information display area 243, for example, an indication of alternative advertisement information CMI2 of the video advertisement CM2 is designated by clicking a mouse (step S19). That is, it means that the user who starts to view the video advertisement CM1 has no interest in the current advertisement and decides to change the video advertisement CM1 to the video advertisement CM2 according to the indicated alternative advertisement information. The user terminal 200 notifies the distribution control unit 121 of the distribution control server 120 of a designation of the video advertisement CM2 that is newly selected. Upon receipt of the designation, the distribution control unit 121 of the distribution control server 120 stops to distribute the video advertisement CM1 to the user terminal 200 (step S20)

Next, the distribution control server 120 updates a content distribution table stored in the distribution information storage unit 122 (step S21) Here, FIG. 4B shows an example of the updated content distribution table. In the example shown in FIG. 4B, the video advertisement CM2 (distribution file CM2) and the latter part of the content A (distribution file A-2) are distributed in this order. Moreover, new alternative advertisement information (e.g. advertisement information CMI7 to CMI11) is displayed during playing of the video advertisement CM2.

A selection of the alternative advertisement information can be performed randomly or be performed based on a presumption of an object of user's interest. When the user views the content A through the user terminal 200, the user's interest can be presumed for example, by using the following behavior:
(1) The user is interested in the content A, but not interested in the video advertisement CM1.
(2) The user is particularly interested in the advertisement information CMI2 among the advertising information CMI2 to CMI6 displayed on a screen and selects the advertisement information CMI2.

Further, the distribution information storage unit 122 in the distribution control server 120 stores update record data of content distribution tables. Since data indicating actual distribution performances on video advertisements can be obtained from the update record data if needed, the data can be utilized as evidence data or the like when an advertisement rate is charged to an advertiser.

Next, the distribution control unit 121 of the distribution control server 120 transmits an updated content distribution table 1212 to the user terminal 200 (step S22). The user terminal 200 which receives the updated content distribution table 1212 refers to the table and requests the alternative advertisement information (advertisement information CMI7 to CMI11) to the distribution control server 120 (step S23). Upon receipt of this request, the distribution control unit 121 of the distribution control server 120 transmits the requested alternative advertisement information to the user terminal 200 (step S24).

Moreover, the user terminal 200 refers to the updated content distribution table and requests a streaming content distribution of the video advertisement CM2 to the distribution control server 120 (step S25). Upon receipt of the request, the distribution control unit 121 of the distribution control server 120 reads out the video advertisement CM2 from the advertisement information storage unit 140 and starts a streaming content distribution thereof to the user terminal 200 (step S26).

The video player of the user terminal 200 changes a screen display so as to display the alternative advertisement information (the advertisement information CMI7 to CMI11) for five alternative advertisements CM7 to CM11 which are obtained in Step S24 (step S27). Also, at the same time, the video player of the user terminal 200 starts to play the video advertisement CM2 (Step S28). Here, FIG. 7 shows an example of a screen display of the video player of the user terminal 200. The screen display includes the image display area 241 where the video advertisement CM2 is played and an alternative advertisement information display area 243 where alternative advertisement information of the five video advertisements (the video advertisements CM7 to CM11) is displayed. Further, in the exemplary embodiment, it is assumed that the alternative advertisement information is not designated by a click operation of a mouse or the like until a completion of playing of the video advertisement CM2. That is, in this case, the user has an interest in the video advertisement CM2 after a change and views the whole of the video advertisement CM2 (for 30 seconds) without changing it to another alternative advertisement any more.

When the streaming content distribution of the video advertisement CM2 is completed, the distribution control unit 121 of the distribution control server 120 notifies the user terminal 200 of completion of the distribution (Step S29). Upon receipt of the notice, the user terminal 200 refers to the updated content distribution table 1212 and requests a streaming content distribution of the latter part of the content A to the distribution control server 120 (step S30). When the distribution control unit 121 of the distribution control server 120 receives this request, the distribution control unit 121 reads out the latter part of the content A from the content storage unit 130 and starts a streaming content distribution thereof to the user terminal 200 (step S31).

The video play unit 240 of the user terminal 200 receives the distribution and starts to play the latter part of the content A (step S32). Here, FIG. 8 shows an example of a screen display of the video player of the user terminal 200. The screen display includes the image display area 241 where the latter part of the content A is played and the operation panel display area 242 where operation buttons such as volume adjustment, pause, fast forwarding are displayed. Finally, when a streaming content distribution of the latter part of the content A is completed, the distribution control unit 121 of the distribution control server 120 notifies the user terminal 200 of completion of the distribution (Step S33).

In the exemplary embodiment, a configuration of a distribution in which one video advertisement is inserted in one content is described. However, a distribution other than the above-mentioned distribution is possible. For example, a plurality of video advertisements may be inserted at a plurality of locations in one content. Such distribution can be easily realized by designating the advertisements using a content distribution table.

In the exemplary embodiment described above, when a video advertisement is played in the user terminal 200, information of another alternative video advertisement (i.e. alternative advertisement information) which can be distributed instead of the video advertisement is displayed together. When an alternative video advertisement is designated, the current video advertisement is changed to the designated alternative video advertisement and a streaming content distribution is continued. Therefore, a user can change a video advertisement to another video advertisement in which a user has an interest even during a distribution of the video advertisement. As a result, since a user actively obtains advertisement information, an advantageous effect on a distribution of a video advertisement is highly promoted.

In the exemplary embodiment, it is not needed to register information about an advertisement to be distributed in advance. Accordingly, a user can quickly start to receive a service without performing a troublesome operation for a registration.

Next, another exemplary embodiment of the present invention will be described in detail with reference to the accompanying drawings. A whole structure (i.e., functional blocks) of another exemplary embodiment of the present invention is the same as that shown in FIG. 1. However the following points are different. That is, when a video advertisement is played, alternative advertisement information displayed by an video player in the user terminal 200 is not information which indicates each alternative video advertisement but information which indicates a genre or a category of a video advertisement. The genre is based on a classification of goods and/or services of advertising objects. Upon receipt of information of a designated genre of the alternative video advertisement from the user terminal 200 during playing of a video advertisement, the distribution control server 120 selects one of video advertisements that belong to the designated genre from the video advertisements that can be distributed. Moreover, the distribution control server 120 distributes the selected video advertisement to the user terminal 200 as an alternative video advertisement.

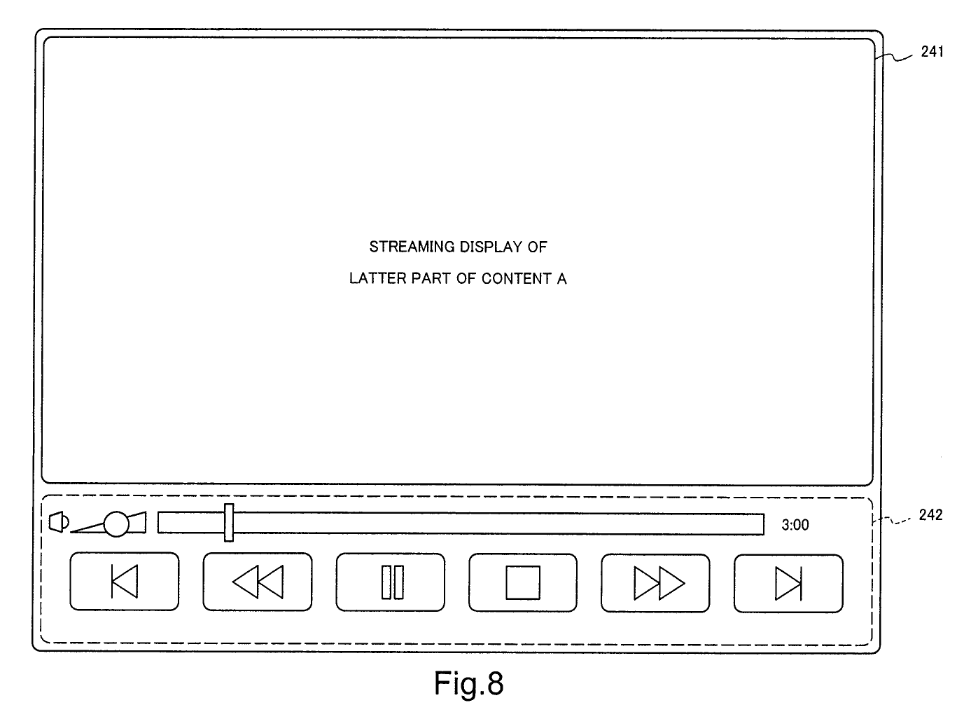

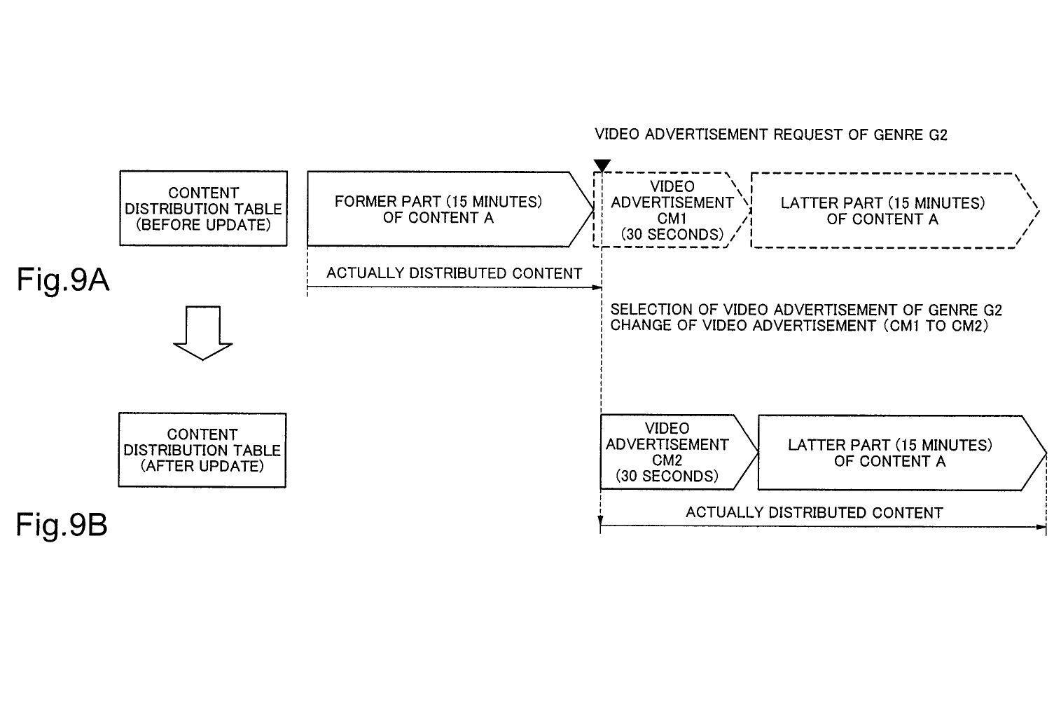

An outline of a streaming content distribution in the whole operation of another exemplary embodiment of the present invention is shown in FIG. 9A and FIG. 9B. With respect to a streaming content distribution to the user terminal 200, first, the whole of a former part of the content A is distributed, and next, a distribution of the video advertisement CM1 is stated (FIG. 9A). Then, five kinds of genre information including genre G2 to G6 are displayed in the alternative advertisement information display area 243. Accordingly, upon receipt of a designation of an advertisement genre G2 in the alternative advertisement information from the user terminal 200, a distribution of the video advertisement CM1 is interrupted. The distribution control unit 121 selects the video advertisement CM2 as a distribution object from a plurality of video advertisements classified into the advertisement genre G2 and updates a content distribution table (FIG. 9B). The distribution control unit 121 distributes the whole content of the video advertisement CM2 to the user terminal 200 and finally, distributes the whole of the latter part of the content A.

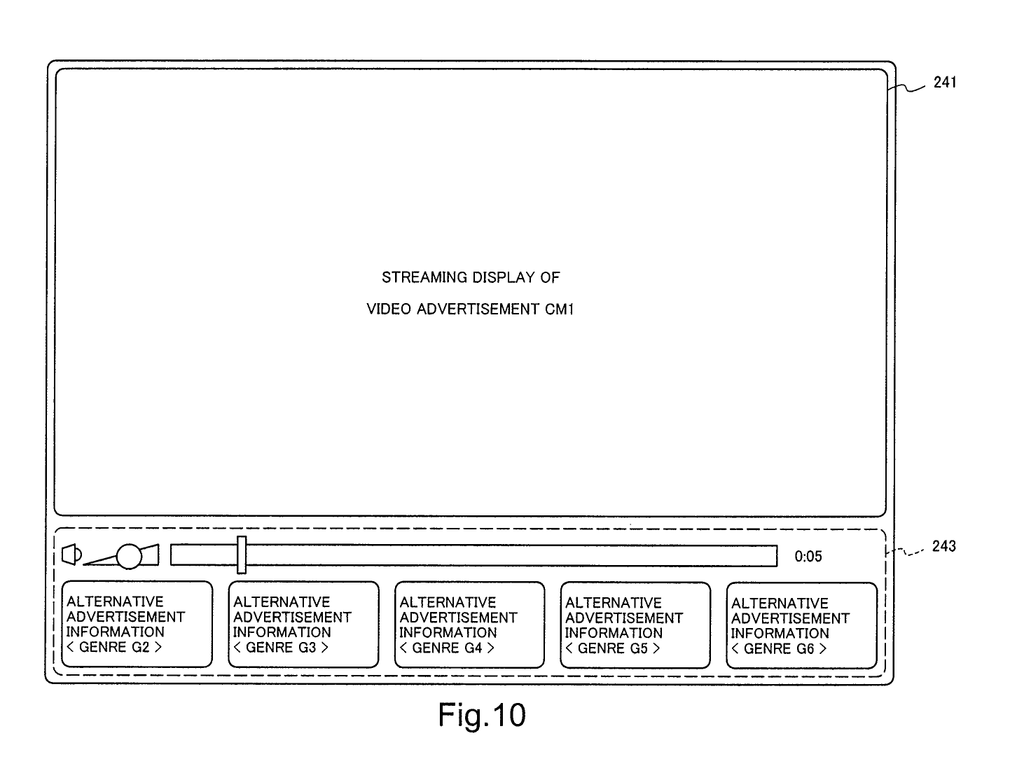

Though operation of another exemplary embodiment of the present invention is basically based on a flowchart shown in FIG. 3, the meaning of “alternative advertisement information” shown in FIG. 3 is changed. That is, “alternative advertisement information” that is transmitted in steps S14 and S24 in FIG. 3 is considered as “genre information” in another exemplary embodiment. In this connection, a screen display of the video player of the user terminal 200 at the time of playing of a video advertisement CM1 in step S18 is changed as shown in FIG. 10. As shown in FIG. 10, the video player plays the video advertisement CM1 that is distributed by a streaming content distribution in the image display area 241 and displays alternative advertisement information of five advertisement genres (the genre G2 to G6) in the alternative advertisement information display area 243.

As an example of a genre of the alternative advertisement information, electrical appliances, foods and beverages, accessories for a dress, medical products, cosmetics, cars and financing services and the like may be considered. A user can designate them with a click operation of a mouse or the like individually. Here, for example, when alternative advertisement information on the genre G2 is designated with a click operation, a content distribution table is updated in step S21.

With respect to a content distribution table of another exemplary embodiment, a content of alternative advertisement information shown in FIG. 4A and FIG. 4B is replaced with genre information. Here, the video advertisement CM2 is selected by the distribution control unit 121 of the distribution control server 120 as an object to be distributed to the user terminal 200 from a plurality of video advertisements that belong to the advertisement genre G2. When a user designates a specific advertisement genre, the distribution control unit 121 can apply an arbitrary criteria for a selection in which video advertisement is selected from a plurality of video advertisements that belong to its genre. For example, the distribution control unit 121 may preferentially select a video advertisement of which an actual performance of distribution (e.g., the number of times of distribution or distribution time) is less than that of a planned performance thereof in a selected genre.

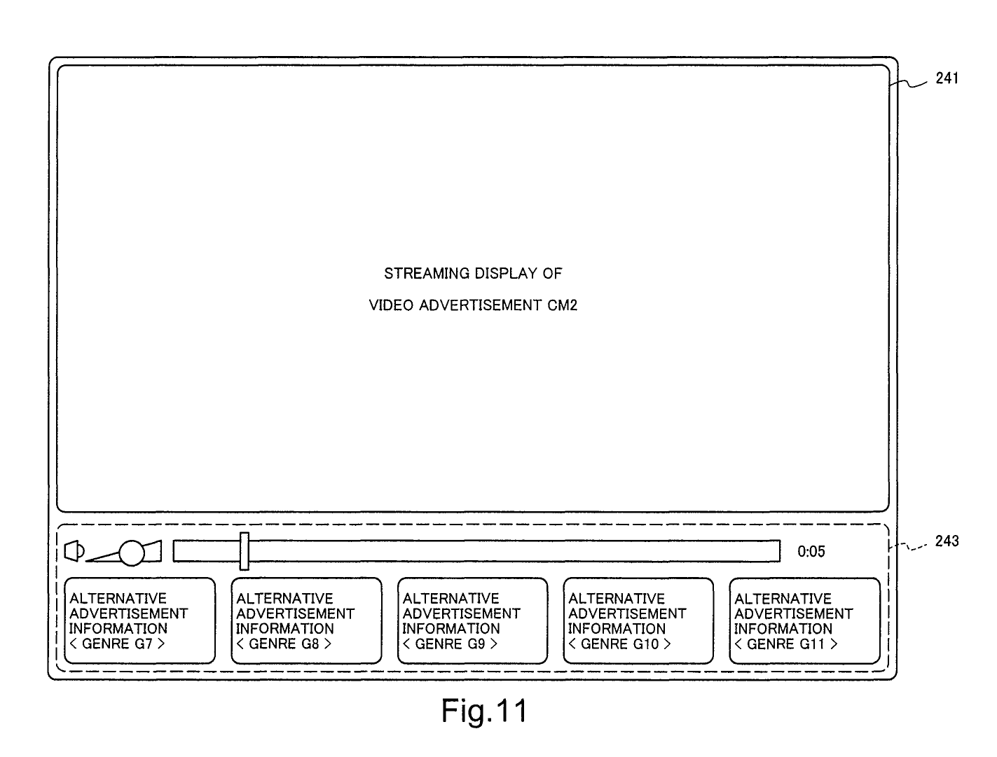

In step S28 shown in FIG. 3, an example of a screen display of the video player of the user terminal 200 at the time of playing of the video advertisement CM2 is like a screen shown in FIG. 11. In FIG. 11, the video player plays the video advertisement CM2 that is distributed through a streaming content distribution in the image display area 241 and displays alternative advertisement information of five advertisement genres (the genres G7 to G11) in the alternative advertisement information display area 243.

As described above, in another exemplary embodiment of the present invention, the alternative advertisement information which a video player plays at the time of playing of a video advertisement in the user terminal 200 is information which indicates a genre of an alternative video advertisement based on a classification on goods and/or services that are advertisement objects. When the user terminal 200 designates a genre of an alternative video advertisement, one of the video advertisements which belong to the designated genre is selected from the video advertisements that can be distributed. The selected video advertisement is distributed to the user terminal 200 as an alternative video advertisement. Hence, since a wider concept (genre) than that of information of each video advertisement is provided as alternative advertisement information, a possibility that a user has an interest in alternative advertisement information becomes high. Accordingly, even when a user does not show an interest in a distributed video advertisement, the user may actively obtains advertisement information by changing, during viewing, a current video advertisement to an alternative video advertisement of a desired genre. As a result, an advantageous effect on a distribution of a video advertisement is highly promoted.

A situation in which an actual performance of distribution of a specific video advertisement falls greatly below a distribution plan is not desirable for a streaming content distribution service operator from the viewpoint of a business operation. However, in another exemplary embodiment mentioned above, when an alternative advertisement selection criteria which gives priority to a video advertisement of which an actual performance of distribution is less than a planned performance thereof is applied, such situation can be avoided.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. Therefore, the present invention is not intended to be limited to the embodiments described herein but is to be accorded the widest scope as defined by the limitations of the claims and equivalents.

Further, it is noted that the inventor's intent is to retain all equivalents of the claimed invention even if the claims are amended during prosecution.

What is claimed is:

1. A streaming content distribution method for distributing a content designated by a user terminal with at least one advertisement, the method comprising:
displaying alternative advertisement information about at least one alternative advertisement to be distributed instead of the advertisement during playing the advertisement at the user terminal; and
changing, when the alternative advertisement information is designated by the user terminal, the advertisement being played to the alternative advertisement corresponding to the designated alternative advertisement information to perform a streaming content distribution of the alternative advertisement.

2. The streaming content distribution method according to claim 1, wherein the alternative advertisement information is information which specifies an advertisement target product of the alternative advertisement.

3. The streaming content distribution method according to claim 1, wherein the alternative advertisement information is information which specifies an advertisement provider of the alternative advertisement.

4. The streaming content distribution method according to claim 1, wherein the alternative advertisement information is information which specifies an advertisement target genre of the alternative advertisement.

5. The streaming content distribution method according to claim 4, wherein a plurality of advertisements in the same advertisement target genre are provided, and wherein an advertisement of which an actual performance of distribution is less than a planed distribution performance in the designated advertisement target genre is distributed as the alternative advertisement.

6. The streaming content distribution method according to claim 1, wherein different alternative advertisement information is selected based on the designated content and of the designated alternative advertisement information, and displayed during playing of the designated alternative advertisement at the user terminal.

7. A streaming content distribution system including a streaming content distribution apparatus connected to a network and a user terminal, the streaming content distribution apparatus distributing a content designated by the user terminal with at least one advertisement, wherein:
the streaming content distribution apparatus transmits alternative advertisement information about at least one alternative advertisement to be distributed instead of the advertisement to the user terminal,
the user terminal displays the alternative advertisement information during playing of the advertisement and notify the streaming content distribution apparatus, when the alternative advertisement information is designated, of the designated alternative advertisement information,
the streaming content distribution apparatus stops a streaming content distribution of the advertisement in response to the notification from the user terminal and starts a streaming content distribution of an alternative advertisement corresponding to the designated alternative advertisement information.

8. The streaming content distribution system according to claim 7, wherein the alternative advertisement information is information which specifies advertisement target product of the alternative advertisement.

9. The streaming content distribution system according to claim 7, wherein the alternative advertisement information is information which specifies an advertisement provider of the alternative advertisement.

10. The streaming content distribution system according to claim 7, wherein the alternative advertisement information is information which specifies an advertisement target genre of the alternative advertisement.

11. The streaming content distribution system according to claim 10, wherein a plurality of advertisements in the same advertisement target genre are provided, and wherein an advertisement of which an actual performance of distribution is less than a planed distribution performance in the designated advertisement target genre is distributed as the alternative advertisement.

12. The streaming content distribution system according to claim 7, wherein different alternative advertisement information is selected based on the designated content and the designated alternative advertisement information, and displayed during playing of the designated alternative advertisement at the user terminal.
